(19) United States
(12) Patent Application Publication
(10) Pub. No.: US 2014/0261934 A1
(43) Pub. Date: Sep. 18, 2014

(54) Vehicle Window Cover

(71) Applicant: Steve Abeyta, Colorado Springs, CO (US)

(72) Inventor: Steve Abeyta, Colorado Springs, CO (US)

(21) Appl. No.: 13/803,273

(22) Filed: Mar. 14, 2013

(51) Int. Cl. B60J 11/08

(52) U.S. Cl. CPC B60J 11/08
USPC 150/168

(57) ABSTRACT

A protective cover for a vehicle window comprising a flexible fabric panel having a terminal edge that includes a roll of the panel fabric where the roll is sized and dimensioned to be disposed beneath a closure component of the vehicle in order to secure the terminal edge in place.

The present invention relates to vehicle covers primarily intended to protect the windows of the vehicle from accumulations of ice and snow.

### BACKGROUND OF THE INVENTION

Protecting the windshield and other windows of a vehicle from accumulations of ice and snow has been the object of a number of prior United States patents. For example, U.S. Pat. No. 4,940,276 to Madison discloses a cover having a size corresponding to the vehicle's outer surface. Similarly, U.S. Pat. No. 4,952,007 to Shahrokh, U.S. Pat. No. 7,673,924 to Lau and U.S. Pat. No. 8,286,688 to Crozier all disclose complete or partial covers for vehicles that include protection for at least some of the windows against ice and snow. The distinction between these various patents focuses on the methods of securing the cover to the vehicle.

The primary object of the present invention is to provide a protective window cover whose attachment features can be employed on a passenger car or a pick-up type of truck and in both cases will be efficient to secure the cover to the vehicle and, at the same time, will be effective in preventing theft of the cover.

### SUMMARY OF THE INVENTION

A protective cover of the present invention is for protecting the windows of a passenger car or pick-up truck and includes a flexible fabric panel that overlays the vehicle roof and depends on its front, rear and sides over the vehicle windows. At least one of the front and rear depending sections has a terminal edge that includes a roll of fabric that is sized and dimensioned to be disposed beneath a closure on the vehicle, for example the hood that covers the engine compartment, the spring biased windshield wipers or the lid of the rear trunk compartment.

### DESCRIPTION OF THE DRAWINGS

FIG. 1 is a perspective view of the vehicle cover of the present invention intended for a passenger automobile.

FIG. 2 is a fragmentary view of a typical passenger car with the rear trunk lid in the open position to reveal the placement of the rolled terminal edge of the rear window panel of the vehicle cover.

FIG. 3 is a fragmentary view of the vehicle of FIG. 2 illustrating the positioning of the rolled terminal edge of the windshield panel beneath the windshield wipers.

FIG. 4 is a perspective view of the vehicle of FIGS. 2 and 3 with the protective cover in position over the vehicle and secured at the front, rear and sides.

FIG. 5 is a perspective view of a typical pick-up truck with the cover of the present invention in place over the cab and the rolled terminal edge of the windshield panel being disposed beneath the rear edge of the hood that covers the engine compartment.

### DETAILED DESCRIPTION OF PREFERRED EMBODIMENTS

The vehicle wrap 2 of the present invention is shown in FIG. 1 and includes a roof central covering portion 4, side window covering pieces 6 and 8 that depend from and are integral with the roof covering portion and rear and front window covering sections 10 and 12 that also depend from and are integral with the roof covering portion 4.

The lower terminal edge 14 of the rear window section 10 is rolled around a semi-rigid core 16 to form a substantially cylindrical lower edge 18 to the rear section 10. The lower terminal edge 20 of the front window section 12 is divided into two axially aligned substantially cylindrical rolled edges 22 and 23, each of which is rolled around respective cores 24 and 25.

The lower terminal edges 30 and 32 of the side pieces 6 and 8 of the wrap 2 are provided with spaced apart side straps 34 and 36 that are equipped with hook and loop type of fasteners in order to selectively form securing loops.

As seen in FIG. 2, the cylindrical terminal edge 18 of the rear window section 10 of the wrap is positioned below the forward rim 40 of the trunk compartment of an automobile 26 so that the terminal edge depends into the upper space of the compartment. When the trunk closure lid 42 is closed the portion of the window section 10 that is just above the cylindrical edge traverses through the space between the compartment rim 40 and the front of the lid 42, trapping the cylindrical rolled edge 18 of rear window section 10 in the trunk compartment and securing the terminal edge of the window section 10 in its proper position, as seen in FIG. 4.

The side straps 34 are adapted to be looped around the handles 51 and 53 of the rear and front door handles of the vehicle and the rear view mirror 60 to secure the side window coverings 6 and 8 in their proper position, as shown in FIGS. 3 and 4.

The front of the wrap 2 is secured in position, as shown in FIG. 3, by positioning the dual and spaced apart lower portions of the windshield covering section that are proximate to the rolled edges 22 and 23 underneath the spring biased windshield wipers 62 and 64 of the vehicle. The rolled edges of the section prevent the window covering section 12 from moving upwardly and thus secure the front portion of the wrap 2 into position.

In an alternative embodiment, as shown in FIG. 5, the wrap 70 is adapted to cover the cab of a pick-up truck 72. In this embodiment the lower terminal edge of the windshield covering section 74 is rolled into a cylindrical shape 75, similar to the rolled rear edge 18 of the first mentioned embodiment. In this pick-up truck version, the rolled front edge is placed under the rear edge 76 of the hood 77 that covers the engine compartment. When the hood is closed the rolled edge 75 is trapped in that compartment to secure the front portion of the wrap in place. Fastening straps 76 are attached to the lower terminal edges of the side pieces 80 that cover the side windows of the truck cab. The terminal edge of the rear window cover section and the terminal edges of the side window pieces 80 are formed into a casing which houses an elastic cord that draws the edges tightly around the cab which, together with the captive front rolled edge 75 and the straps 76, secure the wrap 70 in place.

I claim:

1. A protective cover for vehicle windows comprising,
a flexible fabric wrap having,
a roof covering portion,
side window covering pieces depending from and integral with the roof covering portion and having lower terminal edges,
front and rear window covering sections depending from the roof covering portion and having lower terminal edges where each of the terminal edges of the sections includes at least one tubular shaped roll.

2. The wrap of claim 1 and further including,
a plurality of strap fasteners attached to the lower terminal edges of the side window covering pieces.

3. The wrap of claim 2 where the terminal edge of the front window covering section comprises two spaced apart and axially aligned tubular shaped rolls.

4. The wrap of claim 1 where the terminal edges of the side window covering pieces and the rear window covering section include elastic means for drawing the terminal edges tightly around the vehicle.

5. A protective cover for vehicle windows comprising,
a flexible fabric panel having a terminal edge and means for securing the panel to the outside surface of at least one vehicle window where said securing means includes a roll of the panel fabric at the terminal edge of the panel where the roll is sized and dimensioned to be disposed beneath a closure component of the vehicle.

6. The cover of claim 5 where the vehicle includes windshield wipers and the closure component includes the windshield wipers.

7. The cover of claim 5 where the vehicle includes at least one lid over a compartment and the closure component includes the at least one lid.
